(19) United States
(12) Patent Application Publication
(10) Pub. No.: US 2008/0019320 A1
(43) Pub. Date: Jan. 24, 2008

(54) Method, device, computer program, and apparatus providing embedded status information in handover control signaling

(75) Inventors: Vinh Van Phan, Oulu (FI); Ling Yu, Oulu (FI); Markku J. Vainikka, Kiviniemi (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/879,302

(22) Filed: Jul. 16, 2007

Related U.S. Application Data
(60) Provisional application No. 60/831,858, filed on Jul. 18, 2006.

(51) Int. Cl. H04Q 7/36; H04L 12/24; H04Q 7/00

(52) U.S. Cl. 370/331; 370/332

(57) ABSTRACT

A method providing embedded status information in handover control related messages. The method is operable in an E-UTRAN environment and supports ARQ scheme considerations. A device, computer program and apparatus are also disclosed.

### CROSS-REFERENCE TO RELATED APPLICATION

This patent application claims priority under 35 U.S.C. § 119(e) from Provisional Patent Application No. 60/831,858, filed Jul. 18, 2006, the disclosure of which is incorporated by reference herein in its entirety.

### TECHNICAL FIELD

The exemplary and non-limiting embodiments of this invention relate generally to wireless communication systems, methods, devices and computer program products and, more specifically, relate to techniques for handing over a mobile device from one network node to another.

### BACKGROUND

Certain abbreviations found in the description and/or in the Figures are herewith defined as follows:
3G third generation
3GPP Third Generation Partnership Project
ACK acknowledgment
ARQ automatic repeat request
C-Plane control plane
C-RNTI cell radio network temporary identifier
DL downlink (e.g., eNode B to UE)
eNB E-UTRAN Node B
E-UTRA evolved UTRA
E-UTRAN evolved UTRAN
EPC evolved packet core
HO hand off (handover)
IE information element
L2 layer 2 (the data link layer, e.g., the RLC/MAC layer)
L3 layer 3 (the network layer, e.g., the RRC layer)
LTE long term evolution
MAC medium access control
MME mobility management entity
NACK negative acknowledgment
Node-B base station
PDCP packet data convergence protocol
PDU protocol data unit
PHY physical (Layer 1 or L1)
QoS quality of service
RLC radio link control
RNC radio network controller
RNL radio network layer
RNS radio network subsystem
RNTI radio network temporary identifier
RRC radio resource control
RRM radio resource management
S1 interface between an eNodeB and an MME/SEA gateway
SAE system architecture evolution
SDU service data unit
SIB System Information Block
SN sequence number
SRNS serving RNS
TA timing advance
TNL transport network layer
U-Plane user plane
UE user equipment
UL uplink (e.g., UE to eNode B)
UPE user plane entity
UTRA universal terrestrial radio access
UTRAN universal terrestrial radio access network
X2 interface between two eNodeB

A proposed communication system known as evolved UTRAN (E-UTRAN, also referred to as UTRAN-LTE) is at present a study item within the 3GPP.

One of the E-UTRAN mobility requirements is that the E-UTRAN shall support techniques and mechanisms to optimize packet loss and delay during intra-system HO. In general, an ability to achieve a lossless HO is very desirable in cellular networks. To support lossless HO, it is beneficial for the sender (the UE for the UL and the target eNodeB for the DL) to be aware of the latest status of the receiver (the UE for DL and the source eNodeB for UL) on the received L2 packets immediately prior to the execution of the HO control process in order for the sender to be able to retransmit packets, if necessary, after the HO is completed. See 3GPP TR 25.913 (3rd Generation Partnership Project; Technical Specification Group Radio Access Network; Requirements for Evolved UTRA (E-UTRA) and Evolved UTRAN (E-UTRAN) (Release 7), V7.3.0 (2006-03).

In a current 3G system, the PDCP SN information shown in FIG. 3 is included in the Radio Bearer Control RRC messages for lossless SRNS relocation during a HO initiated by the UE. Note that the receive PDCP sequence number information element specifies the PDCP sequence number that the sender of the message is expecting next to be received.

In UTRAN, the intra-system handover (HO) is the ‘soft HO’ due to W-CDMA. The UE actually initiates the HO by sending a CELL UPDATE message. In UTRAN, there are no direct communications between eNodeBs in supporting the HO.

In Wu (U.S. Patent Publication No. 2003/0210714 A1), PDCP sequence number synchronization procedures follow any RRC procedure that can lead to loss of PDCP PDUs. These procedures include Transport Channel Reconfiguration, Radio Bearer Setup, Radio Bearer Release, and Cell Update procedures, and are characterized in that each of the RRC procedures is capable of initiating an SRNS relocation procedure. A PDCP re-synchronization module detects execution of such an RRC procedure, and in response initiates a PDCP sequence number synchronization procedure.

### SUMMARY

An exemplary embodiment in accordance with this invention is a method for handing over a mobile device from one network node to another. The method includes determining content of a layer 2 status information element. This IE is included into a HO control related RRC message. The resulting message is transmitted. The HO described is initiated by the network and includes communication between a source eNode B and a target eNode B.

Additionally, the status information may include an uplink layer 2 status information element, and where said the HO message is sent to a UE. The HO message may be a HO command message and be transmitted from the source eNode B.

Furthermore, the status information may include a downlink layer 2 status information element and the resulting HO message is sent to a network element. The HO message may be a HO confirm message and be transmitted from a UE to the target eNode B. The HO message may be a HO completed message (or a release resource message) and be transmitted from the target eNode B to the source eNode B.

Additionally, the determination may be based upon at least one of: automatic repeat request; quality of service; available network resources during the HO; and efficiency-simplicity trade-off factors of the network operation and performance.

Furthermore, the status information includes at least one of: last in-order received PDCP/RLC service data unit sequence number; and information descriptive of missing service data units/segments and a last received service data unit/segment.

Additionally, the content of the status information may vary from one HO to another.

A further exemplary embodiment in accordance with this invention is a device for handing over a mobile device from one network node to another. The device includes a circuit configured for determining content of a layer 2 status information element. This IE is included into a HO control related RRC message. The resulting message is transmitted by a transmitter. The HO described is initiated by the network and includes communication between a source eNode B and a target eNode B.

Additionally, the status information may include an uplink layer 2 status information element, and where said the HO message is sent to a UE. The HO message may be a HO command message and be transmitted from the source eNode B.

Furthermore, the status information may include a downlink layer 2 status information element and the resulting HO message is sent to a network element. The HO message may be a HO confirm message and be transmitted from a UE to the target eNode B. The HO message may be a HO completed message (or a release resource message) and be transmitted from the target eNode B to the source eNode B.

Additionally, the determination may be based upon at least one of: automatic repeat request; quality of service; available network resources during the HO; and efficiency-simplicity trade-off factors of the network operation and performance.

Furthermore, the status information includes at least one of: last in-order received PDCP/RLC service data unit sequence number; and information descriptive of missing service data units/segments and a last received service data unit/segment.

Additionally, the content of the status information may vary from one HO to another.

An additional exemplary embodiment in accordance with this invention is signal bearing medium tangibly embodying a program of machine-readable instructions executable by a digital processing apparatus to perform operations for handing over a mobile device from one network node to another. The program includes operations for determining content of a layer 2 status information element. This IE is included into a HO control related RRC message. The resulting message is transmitted. The HO described is initiated by the network and includes communication between a source eNode B and a target eNode B.

Additionally, the status information may include an uplink layer 2 status information element, and where said the HO message is sent to a UE. The HO message may be a HO command message and be transmitted from the source eNode B.

Furthermore, the status information may include a downlink layer 2 status information element and the resulting HO message is sent to a network element. The HO message may be a HO confirm message and be transmitted from a UE to the target eNode B. The HO message may be a HO completed message (or a release resource message) and be transmitted from the target eNode B to the source eNode B.

Additionally, the determination may be based upon at least one of: automatic repeat request; quality of service; available network resources during the HO; and efficiency-simplicity trade-off factors of the network operation and performance.

Furthermore, the status information includes at least one of: last in-order received PDCP/RLC service data unit sequence number; and information descriptive of missing service data units/segments and a last received service data unit/segment.

Additionally, the content of the status information may vary from one HO to another.

A further exemplary embodiment in accordance with this invention is an apparatus for handing over a mobile device from one network node to another. The apparatus includes means for determining content of a layer 2 status information element. This IE is included into a HO control related RRC message. The apparatus includes means for transmitting the resulting message. The HO described is initiated by the network and includes communication between a source eNode B and a target eNode B.

Additionally, the status information may include at least one of an uplink layer 2 status information element and a downlink layer 2 status information element.

Furthermore, the HO control related RRC message may be one of: a HO command message from the source eNode B sent to a user equipment (UE); a HO confirm message from a user equipment (UE) sent to the target eNode B; a HO completed message from the target eNode B sent to the source eNode B; and a release resource message from the target eNode B sent to the source eNode B.

Additionally, the determination may be based upon at least one of: automatic repeat request; quality of service; available network resources during the HO; and efficiency-simplicity trade-off factors of the network operation and performance.

Furthermore, the status information includes at least one of: last in-order received PDCP/RLC service data unit sequence number; and information descriptive of missing service data units/segments and a last received service data unit/segment.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a simplified block diagram of various electronic devices that are suitable for use in practicing the exemplary embodiments of this invention;

FIG. 2 illustrates a message flow diagram of proactive HO that is enhanced in accordance with the exemplary embodiments of this invention;

FIG. 3 shows a conventional PDCP SN information element;

FIG. 4 illustrates a message flow diagram of proactive HO that is enhanced in accordance with another exemplary embodiment of this invention; and

FIG. 5 shows a flow diagram for providing embedded status information in handover control related messages in accordance with the exemplary embodiments of this invention.

### DETAILED DESCRIPTION

The exemplary embodiments of this invention address the problems discussed above, and provide a simple and effective solution subject to optimal response time and radio signaling overhead. However, in the LTE system, as presently proposed, no such information has been introduced for use in HO control-related control messages. This deficiency may be expected to detrimentally impact the performance of the overall HO process in the LTE system when deployed.

An exemplary embodiment of this invention provides for the introduction of L2 status information IEs, which may include RLC and/or PDCP information, in HO control-related messages enabling the sender to obtain a latest ACK/NACK report during the HO execution, which results in a faster lossless handover. In addition, the use of the exemplary embodiments of this invention improves the efficiency of using the radio and transport resources at least for the reason that unnecessary re-transmissions due to a delayed ACK during the HO is avoided.

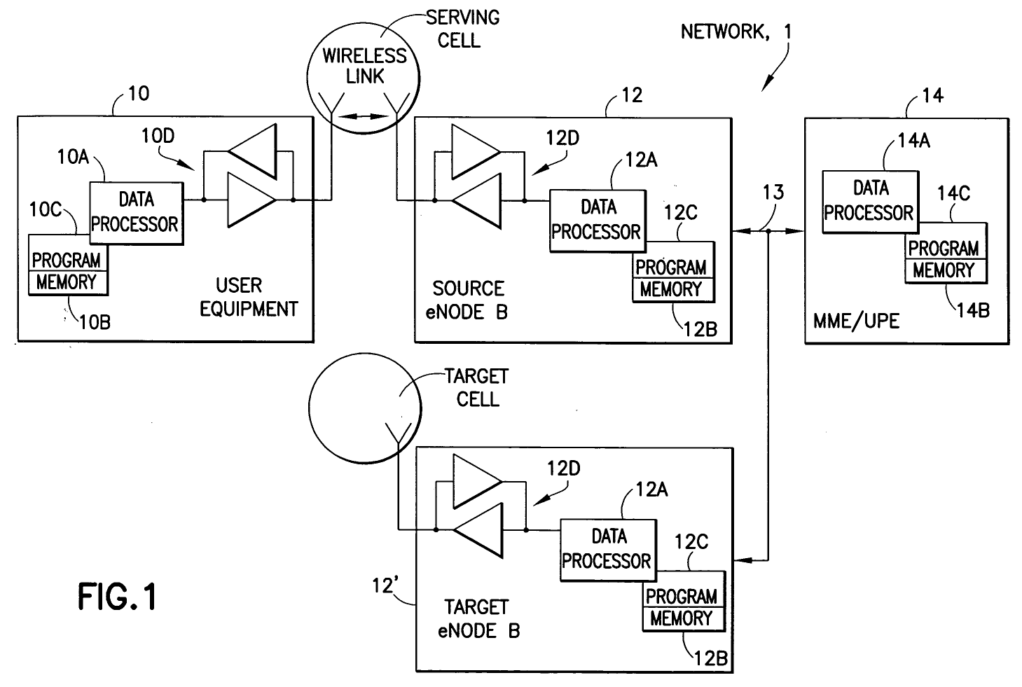

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via at least one Node B (base station) 12 (also referred to herein as an eNode B 12). The network 1 may include a MME/UPE (or an MME/SAE gateway) 14 coupled to the eNode B 12 via a data link 13. The UE 10 includes a data processor (DP) 10A, a memory (MEM) 10B that stores a program (PROG) 10C, and a suitable radio frequency (RF) transceiver 10D for bidirectional wireless communications with the eNode B 12, which also includes a DP 12A, a MEM 12B that stores a PROG 12C, and a suitable RF transceiver 12D. The eNode B 12 is coupled via the data path 13 to the MME/UPE 14 that also includes at least one DP 14A and a MEM 14B storing an associated PROG 14C. At least one of the PROGs 10C, 12C and 14C is assumed to include program instructions that, when executed by the associated DP, enable the electronic device to operate in accordance with the exemplary embodiments of this invention, as will be discussed below in greater detail.

During a HO event that is of interest to the exemplary embodiments of this invention there will at least one second eNode B, referred to as 12′. In the non-limiting example discussed below the eNode B 12 may be considered the Source eNode B, i.e., the eNode B to which the UE 10 is currently connected and communicating in the associated serving cell, and the eNode B 12′ may be considered the Target eNode B, i.e., the eNode B to which the UE 10 is to be connected and communicating with in the target cell after the HO procedure is completed. Note that in practice the serving cell and the target cell may at least partially overlap one another.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the UE 10 and the DP 12A of the eNode Bs 12 and 12′ and 12′, or by hardware, or by a combination of software and hardware.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

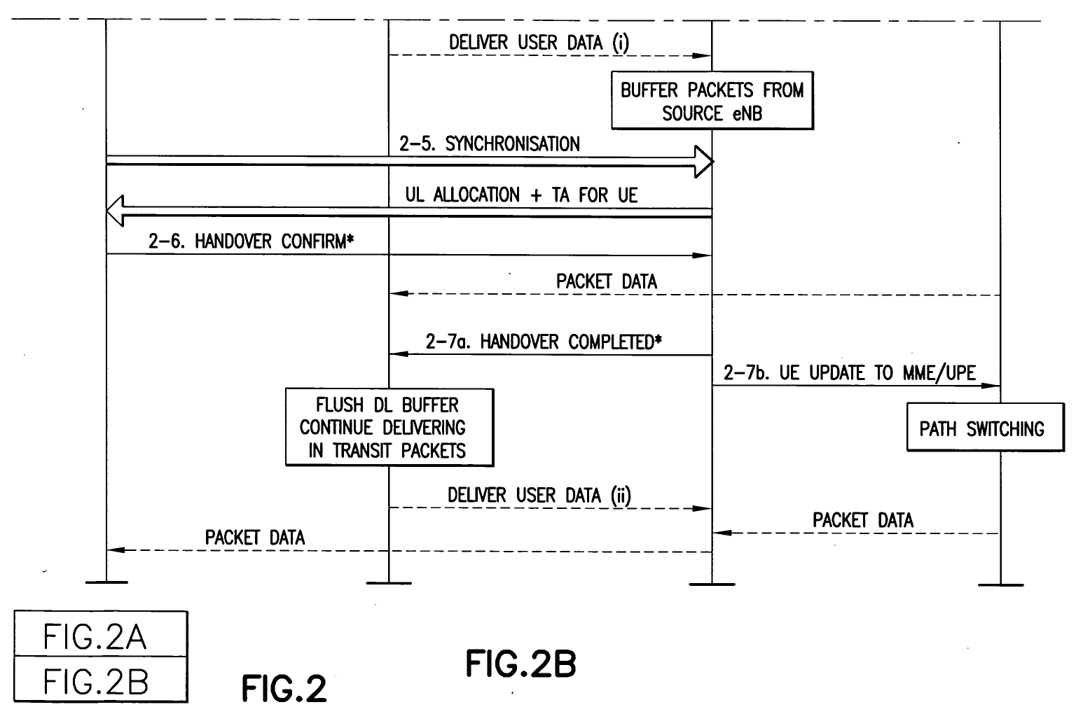

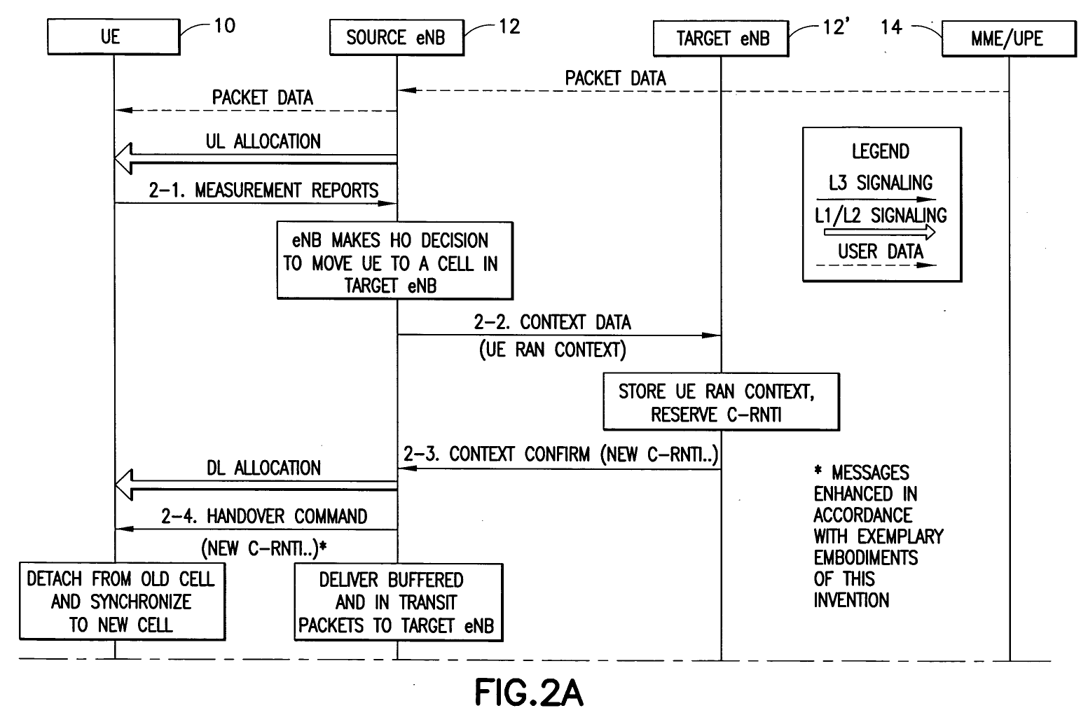

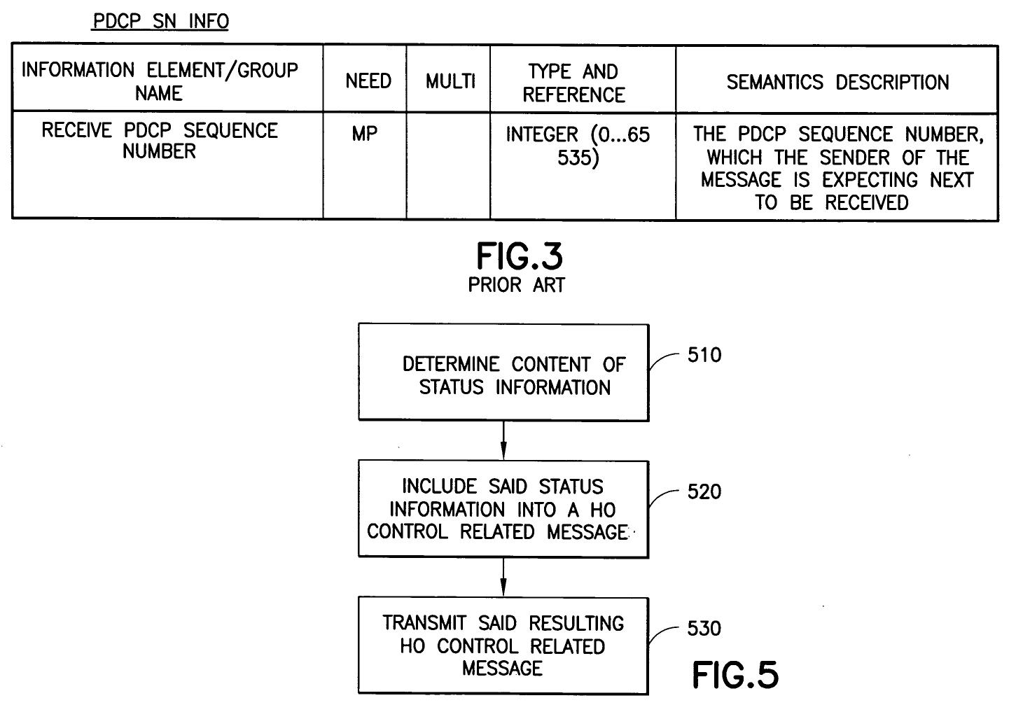

The exemplary embodiments of this invention are beneficial for use in an intra-system HO of a type shown in FIG. 2. More specifically, FIG. 2 illustrate a message flow diagram for a proactive HO that is enhanced in accordance with the exemplary embodiments of this invention to provide L2 system status information, including at least information for specifying a last in-order received PDCP/RLC SDU SN. The devices shown in FIG. 1 are labeled accordingly in FIG. 2.

FIG. 2 is based on FIG. 9.1.5: Intra-MME/UPE HO, taken from 3GPP TR 25.813, V7.0.0 (2006-06), 3rd Generation Partnership Project; Technical Specification Group Radio Access Network; Evolved Universal Radio Access (E-UTRA) and Evolved Universal Radio Access Network (E-UTRAN); Radio interface protocol aspects (Release 7). The HO procedure depicted in FIG. 2 and described below is deemed to be exemplary, and should not be construed as imposing any limitations or restrictions on the practice of the exemplary embodiments of this invention.

In accordance with the exemplary embodiments of this invention at least one L2 status IE, e.g., RLC SN and/or PDCP SN, is included in the HO control-related RRC messages. Taking the HO signaling flow shown in FIG. 2 as a non-limiting example, the UL L2 status information IE may be included in the Handover Command message (message 2-4) from source eNodeB 12 to the UE 10. Further, the DL L2 status information IE may be included in the Handover Confirm message (message 2-6) from UE 10 to the target eNodeB 12′. The DL L2 status information IE may be included in Handover Completed message (message 2-7a) and forwarded from the target eNodeB 12′ to the source eNodeB 12 to avoid unnecessary data forwarding of those L2 packets that are ACKed, such as those with a delayed ACK. In this case the avoidance of re-transmitting ACKed packets can be accomplished.

The three messages that are enhanced in accordance with the exemplary embodiments of this invention are depicted with an asterisk (*) in FIG. 2. The other illustrated HO-related messages and associated procedures 2-1 through 2-3, 2-5 and 2-7b shown in FIG. 2 may operate in a conventional manner.

More specifically, at (2-1) the UE 10 is triggered to send a MEASUREMENT REPORT by rules set by, for example, system information and/or specification. At (2-2) the source eNB 12 makes a decision based on the MEASUREMENT REPORT and RRM information to hand off the UE 10. The source eNB 12 prepares the target eNB 12′ for handover and passes relevant information in the Handover Request. At (2-3) the target eNB 12′ prepares for HO with L1/L2 and responds to the source eNB 12 by providing a new C-RNTI and possibly other parameters, such as access parameters, SIBs, etc. After reception of the accepted preparation of HO, the source eNB 12 starts forwarding data packets to the target eNB 12′. At (2-4*) the UE 10 receives the Handover Command with associated parameters, such as the new C-RNTI, a starting time, target eNB SIBs, etc., from the source eNodeB 12. The UE 10 may acknowledge reception of the Handover Command with a RLC acknowledgment procedure. In accordance with the exemplary embodiments of this invention the UL L2 status information IE may be included in the Handover Command message received from the source eNodeB 12. At (2-5), and after expiry of the starting time in the Handover Command, the UE 10 performs synchronisation to the target eNB 12′ and begins acquiring the UL TA. At (2-6*) the network responds with the UL allocation and TA. These parameters are used by the UE 10 to send the Handover Confirm to the target eNB 12, which completes the handover procedure for the UE 10. The network may acknowledge reception of the Handover Confirm with a RLC acknowledgment procedure. Further in accordance with the exemplary embodiments of this invention the DL L2 status information IE may be included in the Handover Confirm message sent from the UE 10 to the target eNodeB 12′. At (2-7a*) the target eNB 12′ informs success of the HO to the source eNB 12, which may then clear already forwarded data from its buffers. The source eNB 12 may still continue to forward UE 10 data if some remains in its buffers, or if the UPE 14 continues to forward data to it. Further in accordance with the exemplary embodiments of this invention the DL L2 status information IE may be included in the Handover Completed message sent from the target eNodeB 12′ to the source eNodeB 12 to avoid unnecessary data forwarding, as was described above. At (2-7b) the UE 10 location information is updated to the MME/UPE 14 in order to enable the UPE to forward packets directly to the target eNB 12′.

The content of the L2 status information IE, in one simple example, may be just the last in-order received PDCP/RLC SDU SN. As another example, the L2 status information IE may include information descriptive of all missing SDU(s)/segments and the last received SDU/segment, where in general a PDCP PDU is composed of a PDCP SDU and a RLC PDU is composed of RLC SDU(s) and/or segment(s) thereof. The PDCP SN can be different from the RLC SN and the RLC may or may not know of the PDCP SN.

In accordance with the exemplary embodiments of this invention L2 status information IE is introduced and embedded in HO control messages of the RRC that are exchanged between UE 10 and the source/target eNode Bs 12, 12′ as an optional IE.

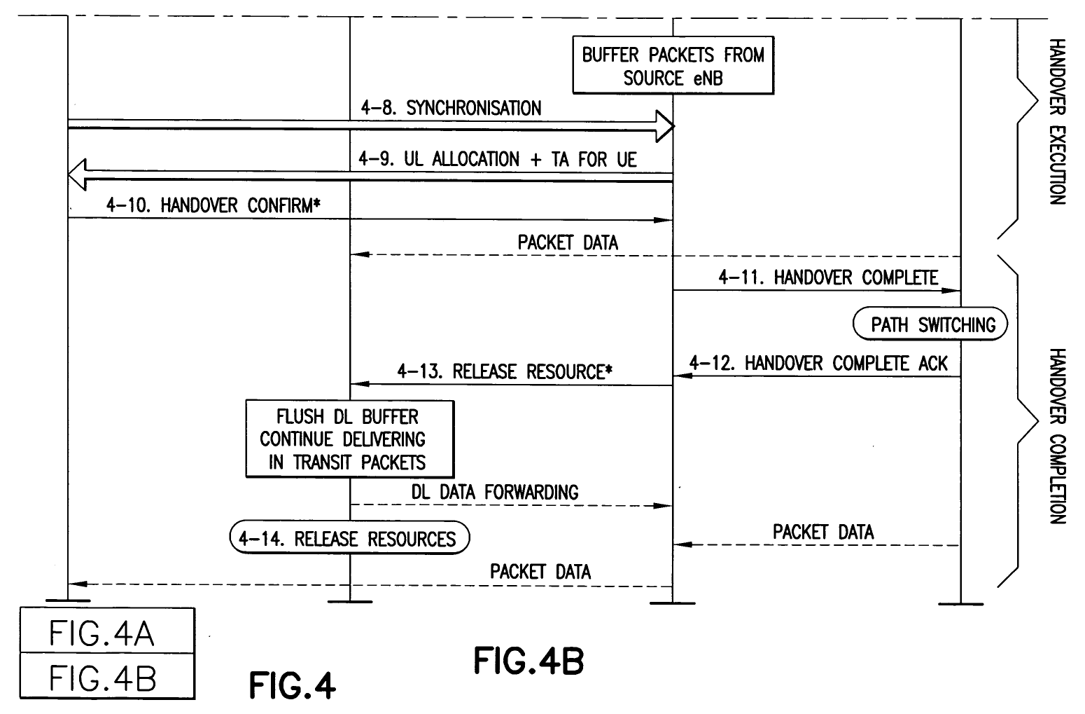

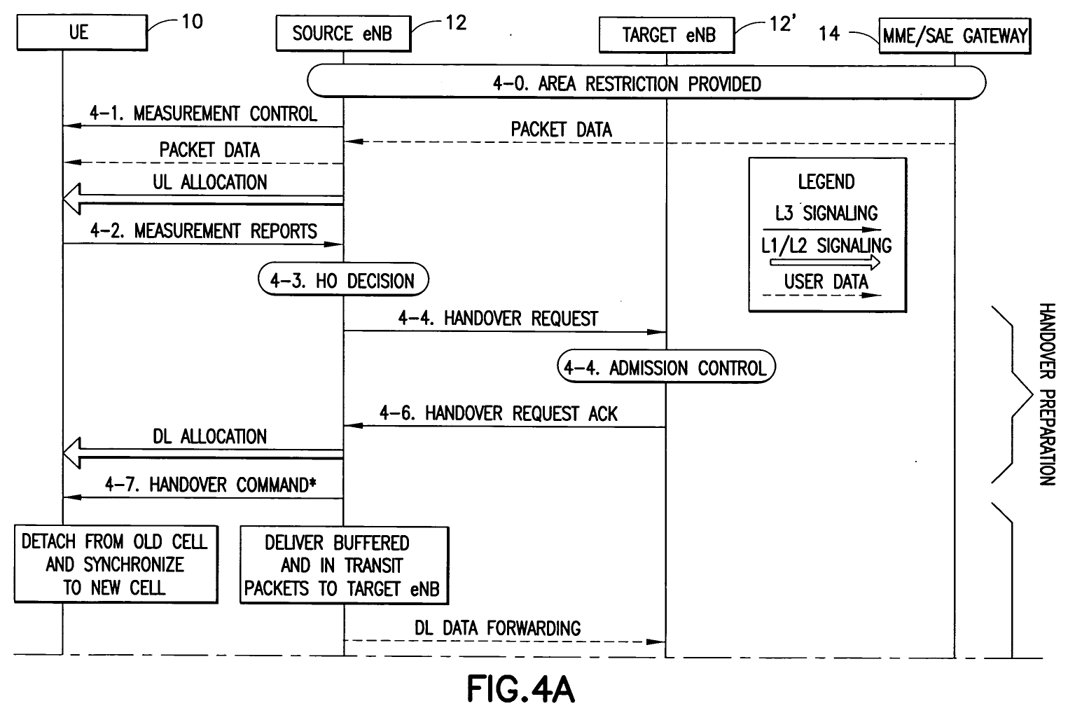

FIG. 4 is based on FIG. 10.1.2.1: Intra-MME/SAE Gateway HO, taken from 3GPP TR 36.300, V8.0.0 (2007-03), 3rd Generation Partnership Project; Technical Specification Group Radio Access Network; Evolved Universal Radio Access (E-UTRA) and Evolved Universal Radio Access Network (E-UTRAN); Overall description; Stage 2 (Release 8). The HO procedure depicted in FIG. 4 and described below is deemed to be exemplary, and should not be construed as imposing any limitations or restrictions on the practice of the exemplary embodiments of this invention.

In accordance with the exemplary embodiments of this invention at least one L2 status IE is included in the HO control-related RRC messages. Taking the HO signaling flow shown in FIG. 4 as a non-limiting example, the UL L2 status information IE may be included in the Handover Command message (message 4-7) from source eNodeB 12 to the UE 10. Further, the DL L2 status information IE may be included in the Handover Confirm message (message 4-10) from UE 10 to the target eNodeB 12′. The DL L2 status information IE may be included in Handover Completed message (message 4-13) and forwarded from the target eNodeB 12′ to the source eNodeB 12 to avoid unnecessary data forwarding of those L2 packets that are ACKed, such as those with a delayed ACK. In this case the avoidance of re-transmitting ACKed packets can be accomplished.

The three messages that are enhanced in accordance with the exemplary embodiments of this invention are depicted with an asterisk (*) in FIG. 4. The other illustrated HO-related messages and associated procedures 4-0 through 4-6, 4-8 through 4-9, 4-11 through 4-12, and 4-14 shown in FIG. 4 may operate in a conventional manner.

At (4-0) the UE 10 context within the source eNB 12 contains information regarding roaming restrictions which where provided either at connection establishment or at the last TA update. At (4-1) the source eNB 12 configures the UE 10 measurement procedures according to the area restriction information. Measurements provided by the source eNB 12 may assist the function controlling the UE's 10 connection mobility. At (4-2) the UE 10 is triggered to send a MEASUREMENT REPORT by the established rules, for example rules set by system information, specification, etc. At (4-3) the source eNB 12 makes a decision to hand off the UE 10 based on the MEASUREMENT REPORT and RRM information. At (4-4) the source eNB 12 issues a HANDOVER REQUEST message to the target eNB 12′ passing necessary information to prepare the HO at the target side (UE X2 signaling context reference at source eNB 12, UE S1 EPC signaling context reference, target cell ID, RRC context, SAE bearer context). UE X2/UE S1 signaling references enable the target eNB 12′ to address the source eNB 12 and the EPC. The SAE bearer context may include any necessary RNL and TNL addressing information. At (4-5) admission control may be performed by the target eNB 12′ dependent on the received SAE bearer QoS information to increase the likelihood of a successful HO, if the resources can be granted by the target eNB 12′. The target eNB 12′ configures the required resources according to the received SAE bearer QoS information and reserves a C-RNTI. At (4-6) the target eNB 12′ prepares HO with L1/L2 and sends the HANDOVER REQUEST ACKNOWLEDGE to the source eNB 12. The HANDOVER REQUEST ACKNOWLEDGE message includes a transparent container to be sent to the UE 10 as part of the handover command. The container may include new C-RNTI, possibly some other parameters, e.g., access parameters, SIBs, etc. The HANDOVER REQUEST ACKNOWLEDGE message may also include RNL/TNL information for the forwarding tunnels, if necessary. At (4-7*) the source eNB 12 generates the Handover command (RRC message) towards the UE 10. The Handover command includes the transparent container, which has been received from the target eNB 12′. The source eNodeB performs the necessary integrity protection and ciphering of the message. The UE 10 receives the Handover command with necessary parameters (e.g., new C-RNTI, possible starting time, target eNB 12′ SIBs etc.) and is commanded by the source eNB 12 to perform the HO. It is probable that UE 10 needs to acknowledge reception of the Handover command with RLC acknowledgment procedure. In accordance with the exemplary embodiments of this invention the UL L2 status information IE may be included in the Handover command message received from the source eNodeB 12. At (4-8) after expiry of the starting time in the Handover command, the UE 10 performs a synchronization to the target eNB 12′ and then starts acquiring the UL timing advance. At (4-9) the network responds with a UL allocation and timing advance. At (4-10*) when the UE 10 has successfully accessed the target cell, the UE 10 sends the Handover confirm message (C-RNTI) to the target eNB 12′ to indicate that the handover procedure is completed for the UE 10. The target eNB 12′ verifies the C-RNTI sent in the Handover confirm message. Further in accordance with the exemplary embodiments of this invention the DL L2 status information IE may be included in the Handover Confirm message sent from the UE 10 to the target eNodeB 12′. At (4-11) the EPC is informed that the UE 10 has changed cells. The UPE switches the downlink data path to the target side and can release any U-plane/TNL resources towards the source eNB 12. At (4-12) the EPC confirms the Handover complete message with the HANDOVER COMPLETE ACK message. At (4-13*) by sending the RELEASE RESOURCE message the target eNB 12′ informs the source eNB 12 of the success of the HO and triggers the release of resources. The timing for the target eNB 12′ to send this message may be anywhere after steps (4-10) or (4-12) and prior to the source eNodeB 12 flushing its DL buffer. Further in accordance with the exemplary embodiments of this invention the DL L2 status information IE may be included in the RELEASE RESOURCE message sent from the target eNodeB 12′ to the source eNodeB 12 to avoid unnecessary data forwarding, as was described above. Upon reception of the RELEASE RESOURCE message at (4-14) the source eNB 12 can release radio and C-plane related resources associated to the UE 10 context.

Setting the content of the L2 status information IE, such as in the aforementioned two examples, may be determined (on a HO-by-HO basis) by the sending side, such as by the L2 receiver. In this manner it is possible to achieve an optimal trade-off between simplicity and efficiency for L2 lossless HO support.

Various criteria may be considered when making a determination as to setting the content of the L2 status information IE. Several non-limiting examples are as follows.

(A) The supported ARQ scheme may be taken into consideration, such as selective ARQ or cumulative go-back-N ARQ (e.g., see D. Bertsekas and R. Gallager, Data Networks, Prentice Hall, 1992). There may also be a hybrid ARQ scheme allowing both selective and cumulative retransmissions on a case-by-case basis. In the go-back-N scheme, the simplest content with the last in-order SDU SN may typically be sufficient. The details of all missing SDU(s)/segments would typically not be needed in the go-back-N approach but selective counterpart. The location and operation of the supported L2 in-order delivery function together with possible reordering of out-of-order received service data units (e.g., which L2 protocol(s) are involved and how) may also be taken into consideration. In E-UTRAN it may be that PDCP is involved in reordering of L2 SDU(s) and L2 in-order delivery at least at HO. In this case, L2 status information should include explicit PDCP status information unless such the PDCP status information were already embedded in RLC status information.

(B) The QoS characteristics or requirements of the user being handed off may be taken into consideration. For example, data losses to some certain extent may be tolerated by some users but not others, which on the other hand may tolerate some certain delay.

(C) The available network resources when the HO occurs may be taken into consideration. For example, the selective re-transmission is generally less resource-consuming, and may be preferred for use under heavy network loading conditions.

(D) The efficiency-simplicity trade-off factors of the network operation and performance may be considered. For simplicity reasons, it may be sufficient to use cumulative re-transmissions for all data users when they are handed off.

The determination of the content of the L2 status information IE may be based on one or more of these considerations, or in combination with yet other considerations.

Also provided is a flexible L2 status information format to limit the HO signaling overhead and thus conserve the use of the bandwidth between the UE 10 and the eNode Bs 12, 12′.

In an exemplary embodiment there is provided a network element, such as the source eNode B 12, that sends UL L2 status information IE in a HO command message to a UE 10.

In another exemplary embodiment there is provided a mobile device, such as a UE 10, that sends a DL L2 status information IE in a HO confirm message to a network element, such as the target eNode B 12′.

In a further exemplary embodiment there is provided a network element, such as the target eNode B 12′, that sends a DL L2 status information IE in a HO completed message to another network element, such as the source eNode B 12.

In another exemplary embodiment there is provided a network element, such as the target eNode B 12′, that sends a DL L2 status information IE in a resource release message to another network element, such as the source eNode B 12.

FIG. 5 shows a method in accordance with a further exemplary embodiment of this invention. In the first step 510, the content of status information is determined. In the second step 520, this status information is embedded into a HO control related message. In the third step 530, the resulting HO control related message is transmitted.

In the foregoing exemplary embodiments the content of the L2 status information IE may comprise a last in-order received L2 SDU SN and/or information descriptive of, for example, missing SDU(s)/segments and a last received SDU/segment.

In the foregoing exemplary embodiments the content of the L2 status information IE may be fixed, or it may be made variable from one instance of a HO to another instance. Various criteria may be taken into consideration when determining the content of the L2 status information IE. These criteria may include, but are not limited to, one or more of: the supported ARQ scheme, the QoS characteristics or requirements of the user being handed off, the available network resources when the HO occurs, and the efficiency-simplicity trade-off factors of the network operation and performance.

Based on the foregoing it should be apparent that the exemplary embodiments of this invention provide a method, apparatus and computer program product(s) to provide HO-related status information in HO control messages that are exchanged between the UE and the source/target eNode Bs.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, message flow diagrams, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
determining content of a layer 2 status information element;
including said status information into a handover (HO) control related radio resource control (RRC) message; and
transmitting said resulting HO control related RRC message, where the HO is initiated by a network and the HO includes communication between a source eNode B and a target eNode B.

2. The method of claim 1, where said status information includes an uplink layer 2 status information element, and further where said resulting HO control related RRC message is sent to a user equipment (UE).

3. The method of claim 1, where said status information includes a downlink layer 2 status information element, and further where said resulting HO control related RRC message is sent to a network element.

4. The method of claim 2, where said transmission originates from the source eNode B, and where said HO control related RRC message is a HO command message.

5. The method of claim 3, where said transmission originates from a user equipment (UE) and sent to the target eNode B, and where said HO control related RRC message is a HO confirm message.

6. The method of claim 3, where said transmission originates from the target eNode B and sent to the source eNode B, and where said HO control related RRC message is a HO completed message.

7. The method of claim 3, where said transmission originates from the target eNode B and sent to the source eNode B, and where said HO control related RRC message is a release resource message.

8. The method of claim 1, where said determination is based upon at least one of:
automatic repeat request;
quality of service;
available network resources during the HO; and
efficiency-simplicity trade-off factors of the network operation and performance.

9. The method of claim 1, where said status information comprises:
a last in-order received radio link control service data unit sequence number;
a last in-order received packet data convergence protocol service data unit sequence number;
information descriptive of missing segments and a last received segment; or
information descriptive of missing service data units and a last received service data unit.

10. The method of claim 1, where the content of said status information is variable from one instance of a HO to another instance.

11. An electronic device comprising:
a circuit configured to determine content of a layer 2 status information element;
a circuit configured to include said status information into a handover (HO) control related radio resource control (RRC) message; and
a transmitter configured to transmit said resulting HO control related RRC message, where the HO is initiated by a network and the HO includes communication between a source eNode B and a target eNode B.

12. The electronic device of claim 11, where said status information includes an uplink layer 2 status information element, and further where said resulting HO control related RRC message is sent to a user equipment (UE).

13. The electronic device of claim 11, where said status information includes a downlink layer 2 status information element, and further where said resulting HO control related RRC message is sent to a network element.

14. The electronic device of claim 12, where said transmission originates from the source eNode B, and where said HO control related RRC message is a HO command message.

15. The electronic device of claim 13, where said transmission originates from a user equipment (UE) and sent to the target eNode B, and where said HO control related RRC message is a HO confirm message.

16. The electronic device of claim 13, where said transmission originates from the target eNode B and sent to the source eNode B, and where said HO control related RRC message is a HO completed message.

17. The electronic device of claim 13, where said transmission originates from the target eNode B and sent to the source eNode B, and where said HO control related RRC message is a release resource message.

18. The electronic device of claim 11, where the content of said status information is variable from one instance of a HO to another instance.

19. The electronic device of claim 11, where said determination is based upon at least one of:
automatic repeat request;
quality of service;
available network resources during the HO; and
efficiency-simplicity trade-off factors of the network operation and performance.

20. The electronic device of claim 11, where said status information comprises:
a last in-order received radio link control service data unit sequence number;
a last in-order received packet data convergence protocol service data unit sequence number;
information descriptive of missing segments and a last received segment; or
information descriptive of missing service data units and a last received service data unit.

21. A signal bearing medium tangibly embodying a program of machine-readable instructions executable by a digital processing apparatus to perform operations comprising:
determining content of a layer 2 status information element;
including said status information into a handover (HO) control related radio resource control (RRC) message; and
transmitting said resulting HO control related RRC message, where the HO is initiated by a network and the HO includes communication between a source eNode B and a target eNode B.

22. The program of claim 21, where said status information includes an uplink layer 2 status information element, and further where said resulting HO control related RRC message is sent to a user equipment (UE).

23. The program of claim 21, where said status information includes a downlink layer 2 status information element, and further where said resulting HO control related RRC message is sent to a network element.

24. The program of claim 22, where said transmission originates from the source eNode B, and where said HO control related RRC message is a HO command message.

25. The program of claim 23, where said transmission originates from a user equipment (UE) and sent to the target eNode B, and where said HO control related RRC message is a HO confirm message.

26. The program of claim 23, where said transmission originates from the target eNode B and sent to the source eNode B, and where said HO control related RRC message is a HO completed message.

27. The program of claim 23, where said transmission originates from the target eNode B and sent to the source eNode B, and where said HO control related RRC message is a release resource message.

28. The program of claim 21, where said determination is based upon at least one of:
automatic repeat request;
quality of service;
available network resources during the HO; and
efficiency-simplicity trade-off factors of the network operation and performance.

29. The program of claim 21, where said status information comprises:
a last in-order received radio link control service data unit sequence number;
a last in-order received packet data convergence protocol service data unit sequence number;
information descriptive of missing segments and a last received segment; or
information descriptive of missing service data units and a last received service data unit.

30. The program of claim 21, where the content of said status information is variable from one instance of a HO to another instance.

31. An apparatus comprising:
means for determining content of a layer 2 status information element;
means for including said status information into a handover (HO) control related radio resource control (RRC) message; and
means for transmitting said resulting HO control related RRC message,
where the HO is initiated by a network and the HO includes communication between a source eNode B and a target eNode B.

32. The apparatus of claim 31, where said status information includes at least one of an uplink layer 2 status information element and a downlink layer 2 status information element.

33. The apparatus of claim 32, where said HO control related RRC message is one of:
a HO command message from the source eNode B sent to a user equipment (UE);
a HO confirm message from a user equipment (UE) sent to the target eNode B;
a HO completed message from the target eNode B sent to the source eNode B; and
a release resource message from the target eNode B sent to the source eNode B.

34. The apparatus of claim 31, where said determination is based upon at least one of:
automatic repeat request;
quality of service;
available network resources during the HO; and
efficiency-simplicity trade-off factors of the network operation and performance.

35. The apparatus of claim 31, where said status information comprises:
a last in-order received radio link control service data unit sequence number;
a last in-order received packet data convergence protocol service data unit sequence number;
information descriptive of missing segments and a last received segment; or
information descriptive of missing service data units and a last received service data unit.
